(19) United States
(12) Patent Application Publication
(10) Pub. No.: US 2024/0269634 A1
(43) Pub. Date: Aug. 15, 2024

(54) METHOD FOR PRODUCING PHOSGENE

(71) Applicant: BASF SE, Ludwigshafen am Rhein (DE)

(72) Inventors: Gerhard OLBERT, Ludwigshafen am Rhein (DE); Torsten MATTKE, Ludwigshafen am Rhein (DE)

(21) Appl. No.: 18/562,358

(22) PCT Filed: May 24, 2022
(86) PCT No.: PCT/EP2022/064111

§ 371 Date: Nov. 20, 2023

(30) Foreign Application Priority Data
May 27, 2021 (EP) 21176199.4

(51) Int. Cl. B01J 8/06; B01J 19/00; C01B 32/80

(52) U.S. Cl. CPC B01J 8/067; B01J 8/065; B01J 19/006; C01B 32/80; B01J 2208/00044; B01J 2208/00176; B01J 2208/00221; B01J 2208/00849

(57) ABSTRACT

The invention relates to a process for producing phosgene by gas phase reaction of carbon monoxide and chlorine in the presence of a solid-state catalyst in a shell-and-tube reactor (1) comprising catalyst tubes (3) which are surrounded by a reactor shell (23) and which accommodate the solid-state catalyst and around which a temperature control medium flows, and baffle plates (27) arranged at right angles to the catalyst tubes (3) in order to generate crossflow of the temperature control medium with respect to the catalyst tubes (3), comprising the following steps:
(a) feeding a gas mixture comprising carbon monoxide and chlorine into the shell-and-tube reactor (1), such that the reaction mixture enters the catalyst tubes (3) at one end;
(b) reacting the carbon monoxide with chlorine to give phosgene in the catalyst tubes (3) to give a phosgene-containing product stream;
(c) withdrawing the phosgene-containing product stream from the shell-and-tube reactor (1),
wherein the amount of liquid temperature control medium in the shell-and-tube reactor (1) is sufficiently large that the temperature of the temperature control medium in the event of failure of the temperature control medium flow reaches the normal boiling point of the temperature control medium no earlier than after 90 s.

The invention proceeds from a process for producing phosgene by gas phase reaction of chlorine with carbon monoxide in the presence of a solid-state catalyst in a shell-and-tube reactor comprising catalyst tubes which are surrounded by a reactor shell and which accommodate the solid-state catalyst, and baffle plates which are arranged at right angles to the catalyst tubes and have passage openings that alternate on opposite sides for a liquid temperature control medium that flows around the catalyst tubes on the inner wall of the reactor shell, where there are no catalyst tubes disposed in the region of the passage openings, comprising the following steps:
(a) feeding a gas mixture comprising carbon monoxide and chlorine into the shell-and-tube reactor, such that the reaction mixture enters the catalyst tubes at one end;
(b) reacting the carbon monoxide with chlorine to give phosgene in the catalyst tubes to give a phosgene-containing product stream;
(c) withdrawing the phosgene-containing product stream from the shell-and-tube reactor,
wherein the liquid temperature control medium flows around the catalyst tubes.

Phosgene is an important auxiliary in the production of intermediates and end products in virtually all branches of chemistry. The greatest area of use in terms of volume is the production of diisocyanates for polyurethane chemistry, especially of tolylene diisocyanate and of 4,4′-diisocyanatodiphenylmethane.

Phosgene is typically produced on an industrial scale in a catalytic gas phase reaction of carbon monoxide and chlorine in the presence of a solid-state catalyst, preferably activated carbon. The reaction is strongly exothermic and is generally conducted in a shell-and-tube reactor by the process described in Ullmann's Encyclopedia of Industrial Chemistry, Wiley-VCH Verlag GmbH & Co. KGaA, Weinheim, pages 625 to 626, DOI: 10.1002/14356007.a19_411.

The catalyst used in the reaction typically has a grain size in the range from 3 to 5 mm, and the tubes used in the shell-and-tube reactor have an internal diameter of 30 to 70 mm. The reaction lights off at a temperature of 40 to 50° C., which rises up to about 580° C. in the tubes and then drops away again. Carbon monoxide is used in a small excess in order to ensure that all the chlorine is converted and in order to obtain chlorine-free phosgene. The reaction can be conducted at ambient pressure or under pressure in order to be able to condense at least a portion of the phosgene even with cooling water.

A corresponding process is described, for example, in WO-A 03/072237. In order to be able to better remove the heat of reaction, a reactor is used here that has a bundle of catalyst tubes arranged parallel to one another in longitudinal reactor direction, secured in tube plates at their ends, each with a hood at either end of the reactor and with baffle plates disposed in the interspace between the catalyst tubes at right angles to longitudinal reactor direction that leave alternately opposite passage openings clear at the inner reactor wall, wherein the catalyst tubes are filled with the solid-state catalyst, the gaseous reaction mixture is directed from one end of the reactor via a hood through the catalyst tubes and drawn off from the opposite end of the reactor via the second hood, and a liquid heat exchange medium is directed through the interspace between the catalyst tubes, and wherein the reactor is tubeless in the region of the passage openings.

In the known processes, in the event of failure of the coolant flow, for example as a result of a fault in the coolant pumps or else in the event of a power failure, there is the risk that the heat released in the reaction will evaporate the coolant and hence the pressure in the coolant circuit will rise significantly, as a result of which the reactor may be damaged. Furthermore, the temperature in the reactor will increase, which can lead to considerable damage on the reactor side in particular, ranging from corrosion up to a chlorine fire.

It is therefore an object of the present invention to provide a process for producing phosgene by gas phase reaction of chlorine in the presence of a solid-state catalyst that offers greater safety in the event of failure of the coolant flow and where, in particular, any significant rise in pressure in the coolant circuit and damage to the reactor on the reaction side can be minimized or even prevented.

The object is achieved by a process for producing phosgene by gas phase reaction of carbon monoxide and chlorine in the presence of a solid-state catalyst in a shell-and-tube reactor comprising catalyst tubes which are surrounded by a reactor shell and which accommodate the solid-state catalyst and around which a temperature control medium flows, and baffle plates arranged at right angles to the catalyst tubes in order to generate crossflow of the temperature control medium with respect to the catalyst tubes, comprising the following steps:
(a) feeding a gas mixture comprising carbon monoxide and chlorine into the shell-and-tube reactor, such that the reaction mixture enters the catalyst tubes at one end;
(b) reacting the carbon monoxide with chlorine to give phosgene in the catalyst tubes to give a phosgene-containing product stream;
(c) withdrawing the phosgene-containing product stream from the shell-and-tube reactor,
wherein the amount of liquid temperature control medium in the shell-and-tube reactor is sufficiently large that the temperature of the temperature control medium in the event of failure of the temperature control medium flow reaches the normal boiling point of the temperature control medium no earlier than after 90 s.

By virtue of the amount of temperature control medium in the shell-and-tube reactor being sufficiently great that the temperature of the temperature control medium in the event of failure of the flow reaches the normal boiling point no earlier than after 90 s, there remains sufficient time to close reactant feeds and hence stop the reaction before the temperature control medium has evaporated to such an extent that the pressure in the coolant circuit rises impermissibly and before further damage such as corrosion or a chlorine fire occurs owing to rising temperatures in the individual catalyst tubes owing to uncooled continuation of the reaction. In this way, it is possible to distinctly improve the safety of the process. After the reactant feed has been closed, the carbon monoxide still present in the catalyst tubes will react with the chlorine still present to give phosgene. Since the carbon monoxide is typically added in a small excess, the reaction will end as soon as all the chlorine has been reacted with the carbon monoxide to give phosgene. Since no further reactants are supplied, the phosgene generated finally will remain in the catalyst tubes when the reactant feed is closed. If the flow of the temperature control medium has not been stopped because of a general power failure, it is preferable, in the event of failure of the flow, to close the reactant feed in an automated manner with a corresponding closed-loop control system. In order to rapidly close the reactant feed even in the event of a general power failure, it is preferable when what are called failsafe valves are used, which close automatically in the event of power failure. Otherwise, it would be necessary to close the feed manually as quickly as possible, in which case a safety reserve of 90 s is generally extremely short, and so it is preferable when the reactant feed is operated manually to keep ready an even greater amount of liquid temperature control medium in order to further prolong the period of time before attainment of the normal boiling point of the temperature control medium.

The normal boiling point refers to the boiling temperature of the temperature control medium at standard pressure, i.e. at 1 bar.

The amount of liquid temperature control medium m_{TM} is preferably determined by:

$${m}_{TM} = \frac{\dot{Q} \cdot 90 s}{{c}_{p} \cdot ( {T}_{s} - {T}_{start} )}$$

with amount of heat of reaction \dot{Q} released in nameplate operation in W, specific heat capacity of the temperature control medium cₚ in J/(kgK), boiling temperature of the temperature control medium Tₛ at standard pressure and temperature of the temperature control medium in normal operation Tₛₜₐᵣₜ, each in K.

The heat of reaction released in nameplate operation is calculated from the amount of reactants used, the conversion and the enthalpy of reaction of carbon monoxide and chlorine to give phosgene. For example, the heat of reaction Q can be determined from the product of the molar flow rate of phosgene at the outlet from the reactor and the enthalpy of reaction, or from the product of chlorine conversion, molar flow rate of chlorine at the inlet into the reactor and the enthalpy of reaction.

The temperature of the temperature control medium in normal operation is the temperature to which the temperature control medium is heated when the reaction is conducted under steady-state conditions with a functioning cooling circuit.

Unless stated otherwise, the “temperature of the temperature control medium” in the reactor refers to the average temperature

$$T = \frac{{T}_{ei𝔫} + {T}_{aus}}{2}$$

with the temperature of the temperature control medium at the reactor inlet Tₑᵢₙ and the temperature of the temperature control medium Tₐᵤₛ at the reactor outlet.

In order to further increase safety and, if necessary, to gain more time before the end of the reaction, it is further preferable when the amount of liquid temperature control medium in the shell-and-tube reactor is sufficiently great that the temperature of the temperature control medium in the event of failure of the temperature control medium flow reaches a temperature of 5 K below the normal boiling point, and especially a temperature of 10 K below the normal boiling point, no earlier than after 90 s. In these cases, in the above equation for determining the amount of liquid temperature control medium, the boiling temperature Tₛ is replaced by Tₛ-5K or Tₛ-10K.

The amount of liquid temperature control medium and the density can be used to determine the necessary volume for the temperature control medium surrounding the catalyst tubes. This volume has to be accommodated by the space in the shell-and-tube reactor that sur-rounds the catalyst tubes. This space generally encloses a volume which is calculated from the free cross-sectional area of the shell-and-tube reactor surrounding the catalyst tubes and the length of the catalyst tubes. The free cross-sectional area of the shell-and-tube reactor surrounding the catalyst tubes is the area surrounded by the inner wall of the shell-and-tube reactor at right angles to the line of the catalyst tubes minus the sum total of the cross-sectional areas of all catalyst tubes. Since the baffle plates also reduce the volume of the space surrounding the catalyst tubes, it is additionally also necessary to subtract the volume of the baffle plates.

The volume of the space in the shell-and-tube reactor through which the temperature control medium flows can be adjusted by conducting different measures. For example, it is possible to adjust the pitch at the tube level such that the necessary free cross-sectional area surrounding the catalyst tubes is attained. The adjustment of the pitch at the tube level has the advantage that the distance between the tubes is sufficiently great, such that local overheating of the temperature control medium in the event of power failure can be minimized or avoided.

Alternatively or additionally to the adjustment of the pitch at the tube level, it is also possible to provide tubeless regions in the shell-and-tube reactor that are filled with temperature control medium. Such tubeless regions may, for example, be the regions where there are passage openings in the baffle plates. In order to adjust the necessary volume of the space through which temperature control medium flows, in the case of a smaller pitch at the tube level, it is necessary to increase the size of the tubeless regions. Alternatively, in the case of a larger pitch, smaller tubeless regions may be provided, provided that the volume of the space through which the liquid temperature control medium flows is sufficiently great to accommodate the amount of liquid temperature control medium needed. If tubeless regions are provided, it is particularly preferable when no catalyst tubes are disposed in the region of passage openings in the baffle plates.

A further means of adjusting the volume of the space through which the liquid temperature control medium flows is to appropriately choose the length of the catalyst tubes around which the temperature control medium flows. Thus, in the case of a relatively small free cross-sectional area surrounding the catalyst tubes, a greater length of the catalyst tubes is required to obtain the volume for the accommodation of the necessary amount of liquid temperature control medium. However, it is important here that an increase in the length of the catalyst tubes does not increase the amount of reactant supplied in normal operation.

In order to conduct the reaction in an existing shell-and-tube reactor in such a way that the amount of temperature control medium is sufficiently large that the amount of liquid temperature control medium in the shell-and-tube reactor is sufficiently large that the temperature of the temperature control medium in the event of failure of the temperature control medium flow reaches the normal boiling point of the temperature control medium no earlier than after 90 s, it is also possible to adjust, generally to reduce, the mass-based space velocity (WHSV) in the shell-and-tube reactor. This is possible, for example, by reducing the reactant mass flow rate supplied.

The aforementioned measures may either each independently be conducted individually in order to adjust the amount of liquid temperature control medium, or it is possible to com-bine two or more measures in order to adjust the amount of liquid temperature control medium.

The reaction for production of phosgene from carbon monoxide and chlorine is preferably conducted in a reactor as described in WO-A 03/072237, wherein at least one of the above-described measures is used to adjust the volume of the space through which the liquid temperature control medium flows in such a way that the amount of liquid temperature control medium in the shell-and-tube reactor is sufficiently large that the temperature of the temperature control medium in the event of failure of the temperature control medium flow reaches the normal boiling point of temperature control medium no earlier than after 90 s.

As an alternative to the reactor described in WO-A 03/072237 with the opposite passage openings on the inner reactor wall, it is alternatively also possible, for example, to use baffle plates that alternately have one passage opening circumferentially on the inner reactor wall and one in the center of the baffle plate. In that case, the temperature control medium in normal operation at first flows from the outside to the middle of the baffle plate, through the passage opening in the middle of the baffle plate onto the baffle plate beneath, in the direction of the inner reactor wall thereon and then through the circumferential passage opening at the inner reactor wall onto the baffle plate beneath, which again has a passage opening in the middle. Since, because of the construction of the shell-and-tube reactor, the temperature control medium is typically added and removed via side feeds in the reactor shell, the uppermost and lowermost baffle plates in this case are provided with a passage opening in the middle. The addition point and withdrawal point for the temperature control medium are above the uppermost baffle plate and below the lowermost baffle plate. As well as the above-described flow from the top downward, it is alternatively also possible to add the temperature control medium at the bottom and remove it at the top, such that it flows from the bottom upward.

In order to further increase the safety of the process, it is further preferable when the temperature control medium is a liquid in which carbon monoxide, chlorine, phosgene and any by-products formed are dissolved without formation of hazardous by-products. Hazardous by-products are understood here to mean all reaction products that can form on reaction of carbon monoxide, chlorine or phosgene with the temperature control medium and can lead to damage to the shell-and-tube reactor, or that can lead to harm to living things or the environment in the event of escape from the reactor at a damaged site.

Suitable temperature control media are, for example, water, decalin, monochlorobenzene, or else heat transfer oils as sold, for example, under the Marlotherm® trade name by Sasol Germany GmbH or under the Galden® HT trade name by Kurt J. Lesker Company.

Working examples of the invention are shown in the figures and will be elucidated in detail in the description that follows.

The figures show:

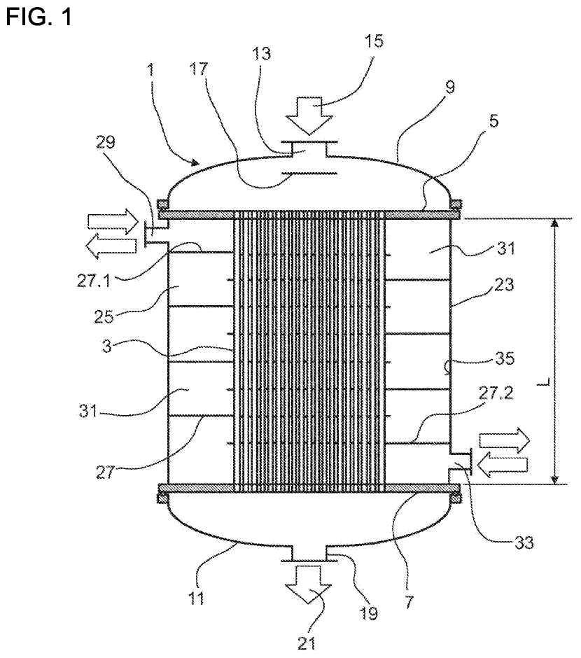

FIG. 1 a shell-and-tube reactor in a first embodiment,

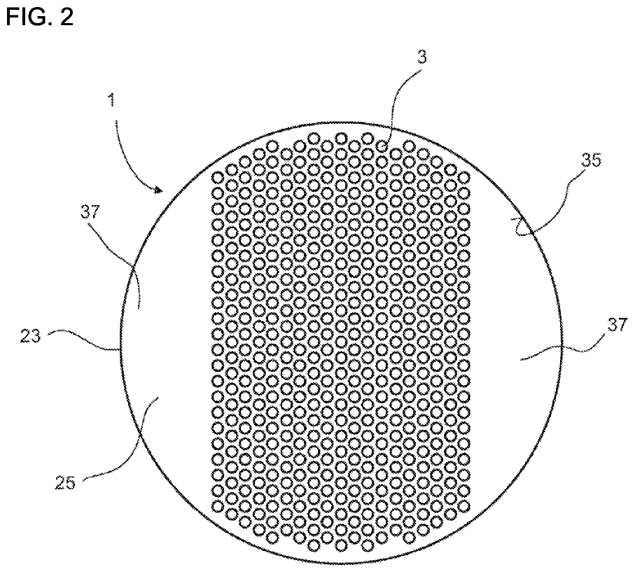

FIG. 2 a cross section through a shell-and-tube reactor according to FIG. 1,

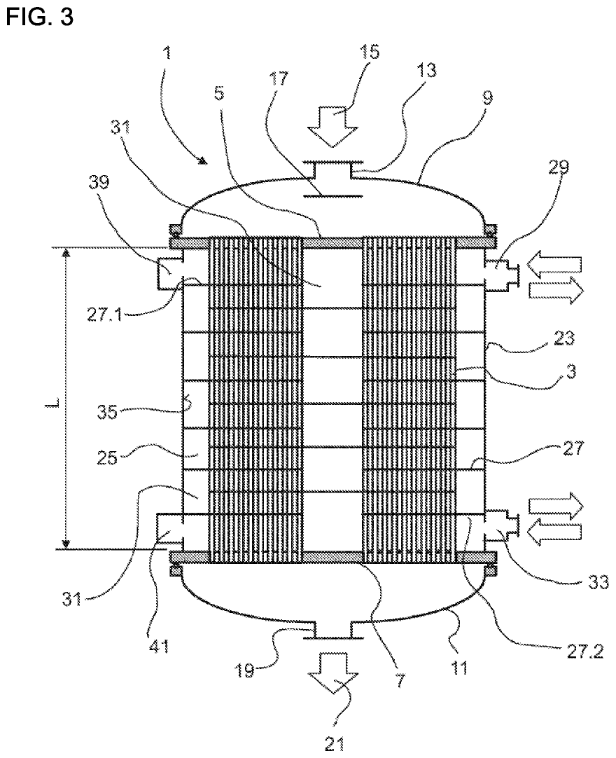

FIG. 3 a shell-and-tube reactor in a second embodiment,

FIG. 4 a schematic diagram of the arrangement of catalyst tubes in a shell-and-tube reactor according to FIG. 2,

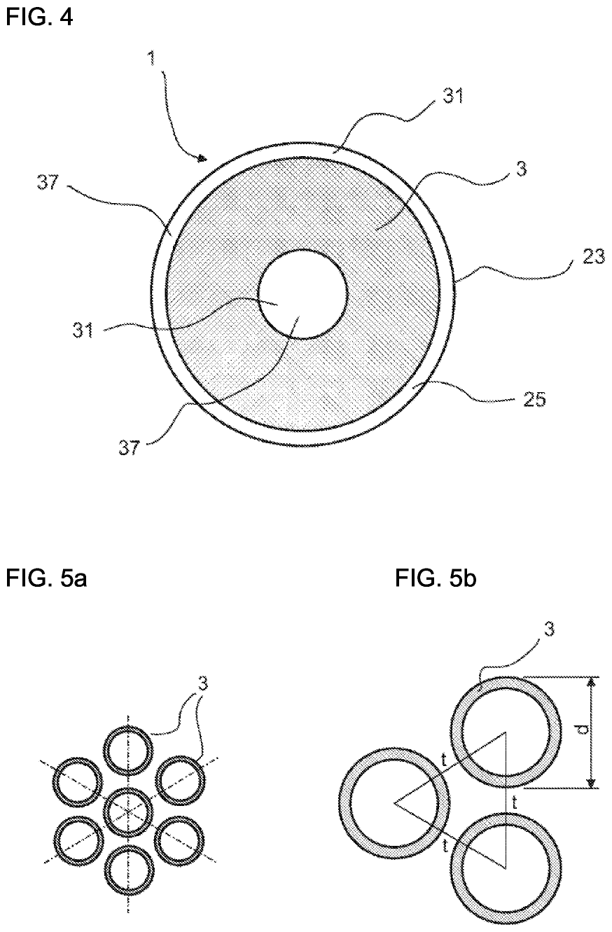

FIGS. 5a, 5b arrangement of the catalyst tubes.

FIG. 1 shows a shell-and-tube reactor in a first embodiment.

A shell-and-tube reactor 1 which is used for production of phosgene from carbon monoxide and chlorine comprises a bundle of catalyst tubes 3 that are arranged parallel to one another in longitudinal direction of the shell-and-tube reactor 1. At their upper end, the catalyst tubes 3 are connected in a gas- and liquid-tight manner to an upper tube sheet 5, and at their lower end to a lower tube sheet 7.

At the upper end, the shell-and-tube reactor 3 is closed with an upper hood 9, and at the lower end with a lower hood 11. The upper hood 9 has a feed 13 via which a reactant stream 15 comprising carbon monoxide and chlorine is fed in. In order that the chlorine is fully depleted in the reaction to give phosgene, it is preferable to feed in the carbon monoxide in excess. In order to distribute the reactant stream 15 uniformly between the catalyst tubes 3, a gas distributor 17 is preferably disposed in the upper hood 9. With the aid of the gas distributor 17, the gas mixture fed in as reactant stream 15 is distributed uniformly beneath the upper hood 9 and then flows into the catalyst tubes 3.

After flowing through the catalyst tubes 3, the crude product produced in the catalyst tubes 3 is collected in the lower hood 11 and withdrawn as crude product stream 21 via a draw 19.

Since the reaction is conducted in the presence of a solid-state catalyst, the catalyst tubes 3 are filled with the solid-state catalyst. The solid-state catalyst used is preferably activated carbon in the form of a catalyst bed. The catalyst bed in the catalyst tubes 3 preferably has an external gap volume of 0.33 to 0.5 and especially of 0.33 to 0.4. The catalyst particles that are used in the catalyst bed typically have an internal gap volume of 0.6 to 0.7.

The gap volume e is determined as:

$$ε = \frac{ρ - {ρ}_{s}}{ρ}$$

For the internal gap volume, the density of the solid is used for p, and the density of a catalyst particle for pₛ. For the external gap volume, the density of a catalyst particle is used for p, and the density of the catalyst bed for pₛ.

The reaction of carbon monoxide and chlorine to give phosgene is strongly exothermic, and so it is necessary to cool the catalyst tubes 3. For this purpose, the shell-and-tube reactor 1 has a reactor shell 23 surrounding the bundle of catalyst tubes 3. In this way, the reactor shell 23 bounds a space 25 through which a temperature control medium flows in normal operation. The temperature control medium absorbs heat generated in the reaction, which is then released in a heat exchanger in the cooling circuit.

In order to very effectively cool the catalyst tubes 3, it is advantageous when the temperature control medium flows transverse to the line of the catalyst tubes 3. For this purpose, baffle plates 27 that are accommodated in the space 25 surrounding the catalyst tubes 3 are aligned at right angles to the catalyst tubes. The temperature control medium thus flows parallel to the line of the baffle plates 27 from a feed 29 firstly between upper tube sheet 5 and the uppermost baffle plate 27.1 to a passage opening 31, through which the temperature control medium flows onto the baffle plate 27 beneath, and then between two baffle plates in each case to the next passage opening 31, until the temperature control medium, after flowing through the passage opening 31 in the lowermost baffle plate 27.2, flows between the lowermost baffle plate 27.2 and the lower tube sheet 7 to a drain 33.

As an alternative to the above-described flow of the temperature control medium from the top downward, it is also possible that the temperature control medium is fed in via the drain 33 and removed via the feed 31, such that the functions of feed and drain are exchanged and the temperature control medium flows in the opposite direction from the bottom upward.

For uniform cooling of all catalyst tubes 3, it is preferable when there are no catalyst tubes positioned in the region of the passage openings 31 in the shell-and-tube reactor. In this way, it is ensured that the flow of the temperature control medium toward all catalyst tubes is transverse to their line.

The shell-and-tube reactor 1 is preferably configured such that it comprises 100 to 10 000, especially 1000 to 3500, catalyst tubes 3. The catalyst tubes are preferably formed from a corrosion-resistant material, for example stainless steel, especially duplex steel 1.4462, stainless steel 1.4571 or stainless steel 1.4541, or from a nickel-base alloy, especially Hastelloy® or Inconel*. More preferably, the entirety of the shell-and-tube reactor 1 is formed from one of these materials. As an alternative to the use of corrosion-resistant material, it is also possible to provide all surfaces that come into contact with the reaction mixture and all surfaces that come into contact with the temperature control medium, especially the surfaces that come into contact with the reaction mixture, with a corrosion-resistant and heat-resistant coating, for example enamel. However, it is preferable to manufacture the catalyst tubes 3 and especially the entirety of the shell-and-tube reactor 1 from a corrosion-resistant material, especially duplex steel or stainless steel.

Each catalyst tube 3 preferably has a wall thickness in the range from 2 to 4 mm, especially from 2.5 to 3 mm, and an internal tubular diameter in the range from 20 to 90 mm, especially in the range from 30 to 50 mm. The external diameter of the catalyst tubes is thus preferably in the range from 24 to 98 mm and especially in the range from 35 to 58 mm. The length L of the catalyst tubes 3 is preferably in the range from 1.5 to 6 m, especially in the range from 2 to 4 m.

The reactor shell 23 may have any desired cross-sectional shape, but the reactor shell 23 preferably has a circular cross section, and so the shell-and-tube reactor 1 is cylindrical in the region between the upper tube sheet 5 and the lower tube sheet 7. In such a cylindrical configuration of the shell-and-tube reactor 1, the internal diameter is preferably 0.5 to 6 m and especially 1 to 4 m.

In the embodiment shown in FIG. 1, the passage openings 31 of baffle plates arranged one on top of another alternate with one another on opposite sides of the inner reactor wall 35.

In order to be able to end the reaction in the event of failure of the temperature control medium flow before damage to the shell-and-tube reactor occurs, the space 25, in accordance with the invention, is sufficiently large that the temperature control medium present therein reaches the normal boiling point of the temperature control medium no earlier than after 90 s in the event of failure of the flow.

In order to make the volume of the space 25 sufficiently large, in order that it can accommodate the necessary amount of temperature control medium, in order that it reaches the normal boiling point of the temperature control medium no earlier than after 90 s, the free cross-sectional area of the space 25 must be sufficiently large, depending on the length L of the catalyst tubes 3. The free cross-sectional area is found from the area enclosed by the inner reactor wall 35 at right angles to the line of the catalyst tubes minus the area occupied by the catalyst tubes 3. In FIG. 2, which shows a cross section of the shell-and-tube reactor 1 shown in FIG. 1, this area is the area within the inner reactor wall 35 and outside the catalyst tubes 3. The large tubeless areas 37 in the region of the passage openings 31 already achieves a distinctly greater volume that can be occupied by the temperature control medium than in the case of a shell-and-tube apparatus filled completely with tubes. In order to obtain a sufficiently large volume for the temperature control medium, it is possible to increase the size of the tubeless areas 37 in the region of the passage openings 31 or the distance between the catalyst tubes 3.

FIGS. 3 and 4 show a shell-and-tube reactor in a second embodiment, where FIG. 3 shows a longitudinal section through the shell-and-tube reactor 3 and FIG. 3 a cross section.

By contrast with the shell-and-tube reactor 1 shown in FIGS. 1 and 2, in the shell-and-tube reactor shown in FIGS. 3 and 4, the passage openings 31, rather than alternating on opposite sides of the inner reactor wall, alternate between one in the middle of the baffle plate 27 and one peripherally at the edge of the baffle plate 31. In this way, the temperature control medium flows firstly to the middle of the uppermost baffle plate 27.1, through the passage opening 31 in the middle, across the baffle plate 27 beneath to the edge, through the peripheral passage opening 31 at the edge onto the baffle plate 27 beneath, and back to the middle thereon, such that the temperature control medium flows from the edge to the middle and back again in a meandering manner. The lowermost baffle plate 27.1 preferably has the passage opening in the middle, such that the temperature control medium flows to the edge and thence to the drain 33. For uniform supply and removal of the temperature control medium, in the embodiment shown in FIGS. 3 and 4, it is preferable when the temperature control medium flows from the feed 29 firstly into an annular channel 39 and via the annular channel 39 into the space 25 surrounding the catalyst tubes 3. After flowing through the space 25 in a meandering manner, the temperature control medium then flows into a second annular channel 41 and through the annular channel 41 to the drain 33, via which the temperature control medium is withdrawn. The annular channels 39, 41 ensure that, even above the uppermost baffle plate 27.1 and below the lowermost baffle plate 27.2, there is flow of the temperature control medium around all catalyst tubes, and that the temperature control medium does not flow directly to the drain 33.

The catalyst tubes 3 are preferably disposed in triangular pitch in the shell-and-tube reactor. This is shown schematically for a few catalyst tubes 3 in FIGS. 5a and 5b.

In the case of a triangular pitch in the form of an equilateral triangle, six catalyst tubes 3 in each case surround a seventh catalyst tube 3. The distances both between adjacent catalyst tubes 3 surrounding the seventh catalyst tube 3 and the distances between the surrounding catalyst tubes and the seventh catalyst tube are each the same, and are referred to as pitch t. This is shown by way of example for three catalyst tubes 3 in FIG. 5b. The catalyst tubes 3 each have an external diameter d, and the pitch t is the distance between the centers of two adjacent catalyst tubes 3. In order that adjacent catalyst tubes are not in contact, such that it is possible for the temperature control medium to flow around them, it is necessary for the pitch t to be greater than the external diameter d of the catalyst tubes 3.

### EXAMPLES

### Comparative Example 1

For production of 10 t/h of phosgene, a shell-and-tube reactor comprising 1256 catalyst tubes with an external diameter of 44.5 mm and a length of 2.5 m is used. The pitch of the tube level is 55 mm, and the shell-and-tube reactor has an internal diameter of 2.05 m. This results in an amount of temperature control medium in the shell-and-tube reactor of about 3 m³. The temperature control medium used is monochlorobenzene with an average temperature in the shell-and-tube reactor in normal operation of 80° C. With a density of 1044 kg/m³, this results in an amount of about 3.15 t of monochlorobenzene in the shell-and-tube reactor. In the production of 10 t/h of phosgene, with a heat of reaction of about 110 kJ/mol, an amount of heat of about 3.09 MW is released. The normal boiling point of monochlorobenzene is 132° C. With a heat capacity of about 1417 J/kgK, this results in heating of the monochlorobenzene in the reactor from 80° C. to 132° C. within about 75 s.

Comparative example 2 according to WO-A 2003/072237:

A reactor for production of 10 t/h of phosgene is designed as a shell-and-tube reactor having 1256 tubes with an external diameter of 44.5 mm and a tube length of 3 m. The tube section having contact with the temperature control medium (total tube length minus the thickness of the tube sheets and of the baffle plates) is 2.5 m. The pitch of the tube level is 51 mm, corresponding to an internal reactor diameter of about 1.90 m. The holdup of temperature control medium in the reactor is about 1.9 m³. The temperature control medium used is monochlorobenzene with an average temperature in the reactor of 80° C. With a density of 1044 kg/m³, there is an amount of about 1.99 t within the reactor. In the production of 10 t/h of phosgene, with a heat of reaction of approximately 110 kJ/mol, an amount of heat of approximately 3.09 MW is released. With the heat capacity of monochlorobenzene of about 1417 J/kgK, the result is heating of the monochlorobenzene from 80° C. to 132° C. within about 47 s.

Comparative example 3 according to WO-A 2003/072237:

By introduction of a tubeless region in accordance with WO-A 2003/072237 of about 15% of the total cross-sectional area of the reactor with the same number of tubes and a pitch of 51 mm, the reactor diameter is increased to 2.06 m and the holdup of temperature control medium to 3.13 m³, corresponding to 3.27 t of monochlorobenzene. The heating time of the monochlorobenzene from 80° C. to 132° C. is about 78 s.

### Example 1

The tubeless region in the region of the passage openings of the baffle plates is increased to about 15% of the total cross-sectional area of the shell-and-tube reactor. This increases the reactor diameter to 2.22 m for the same number of catalyst tubes and the same pitch of 55 mm by comparison with comparative example 1, and hence the amount of temperature control medium in the shell-and-tube reactor to 4.43 m³, corresponding to 4.63 t of monochlorobenzene. This increases the heating time of the monochlorobenzene from 80° C. to 132° C. to about 110 s.

### Example 2

In the reactor according to comparative example 2, the pitch of the tube level is increased from 51 mm to 58 mm. The reactor diameter increases to 2.17 m, and the holdup of temperature control medium to 3.9 m³ or 4.07 t of monochlorobenzene. The heating time of the monochlorobenzene is increased to 97 s.

### Example 3

In the reactor according to comparative example 3, the proportion of the tubeless region in the total cross-sectional area of the reactor is increased to 20%. The reactor diameter increases to 2.12 m, and the holdup of temperature control medium to 3.64 m³, or 3.8 t of monochlorobenzene. The heating time of the monochlorobenzene is increased to 90.6 s.

### Example 4 (Increased Tube Length)

In the reactor according to comparative example 3, with the same proportion by area of the tubeless region, the tube length is increased to 3.5 m, corresponding to a tube length having contact with the temperature control medium of 3 m. The holdup of temperature control medium increases to 3.82 m³, or 4.0 t of monochlorobenzene. The heating time of the monochlorobenzene is increased to 95 s.

### Example 5 (Combination of Measures)

In the reactor according to comparative example 3, the proportion by area of the tubeless region is increased to 18%, the pitch to 52 mm, and the tube length to 3.3 m (2.8 m having contact with the temperature control medium). The holdup of temperature control medium increases to 4.82 m³, or 5.0 t of monochlorobenzene. The heating time of the monochlorobenzene is increased to 120 s.

### Example 6

By comparison with comparative example 1, the pitch is increased from 55 mm to 60 mm. This increases the internal reactor diameter to 2.23 m, corresponding to a holdup of temperature control medium of 4.51 m³ or 4.71 t of monochlorobenzene. The heating time of the monochlorobenzene from 80° C. to 132° C. is increased to about 112 s.

### Example 7

The difference from comparative example 1 is an increase in tube length from 2.5 m to 3 m. With the same reactor diameter, the holdup of temperature control medium is increased to 3.7 m³, corresponding to 3.84 t of monochlorobenzene. The heating time of the monochlorobenzene from 80° C. to 132° C. is about 92 s.

### LIST OF REFERENCE NUMERALS

1 shell-and-tube reactor
3 catalyst tube
5 upper tube sheet
7 lower tube sheet
9 upper hood
11 lower hood
13 feed
15 reactant stream
17 gas distributor
19 draw
21 crude product stream
23 reactor shell
25 space
27 baffle plate
27.1 uppermost baffle plate
27.2 lowermost baffle plate
29 feed
31 passage opening
33 drain
35 inner reactor wall
37 tubeless area
39 annular channel
41 second annular channel

1.-7. (canceled)

8. A process for producing phosgene by gas phase reaction of carbon monoxide and chlorine in the presence of a solid-state catalyst in a shell-and-tube reactor comprising catalyst tubes which are surrounded by a reactor shell and which accommodate the solid-state catalyst and around which a temperature control medium flows, and baffle plates arranged at right angles to the catalyst tubes in order to generate crossflow of the temperature control medium with respect to the catalyst tubes, comprising the following steps:
(a) feeding a gas mixture comprising carbon monoxide and chlorine into the shell-and-tube reactor, such that the reaction mixture enters the catalyst tubes at one end;
(b) reacting the carbon monoxide with chlorine to give phosgene in the catalyst tubes to give a phosgene-containing product stream;
(c) withdrawing the phosgene-containing product stream from the shell-and-tube reactor, wherein the amount of liquid temperature control medium in the shell-and-tube reactor is sufficiently large that the temperature of the temperature control medium in the event of failure of the temperature control medium flow reaches the normal boiling point of the temperature control medium no earlier than after 90 s.

9. The process according to claim 8, wherein the minimum amount of liquid temperature control medium is determined by:
$${m}_{TM} = \frac{\dot{Q} \cdot 90 s}{{c}_{p} \cdot ( {T}_{s} - {T}_{start} )}$$
with heat of reaction Q released in nameplate operation, specific heat capacity of the temperature control medium cₚ, boiling temperature of the temperature control medium Tₛ at standard pressure and temperature of the temperature control medium in normal operation Tₛₜₐᵣₜ.

10. The process according to claim 8, wherein the volume for accommodation of the necessary amount of liquid temperature control medium is determined by the free cross-sectional area of the shell-and-tube reactor surrounding the catalyst tubes and the length of the catalyst tubes.

11. The process according to claim 8, wherein the free cross-sectional area surrounding the catalyst tubes is determined by the external diameter of the catalyst tubes, the pitch and/or the size of tubeless regions of the shell-and-tube reactor.

12. The process according to claim 8, wherein there are no catalyst tubes disposed in the region of passage openings in the baffle plates.

13. The process according to claim 8, wherein the temperature control medium is a liquid in which carbon monoxide, chlorine, phosgene and any by-products formed are dissolved without formation of hazardous by-products.

14. The process according to claim 8, wherein the temperature control medium is selected from water, decalin, monochlorobenzene and heat carrier oils.
